(19) United States
(12) Patent Application Publication
(10) Pub. No.: US 2026/0067415 A1
(43) Pub. Date: Mar. 5, 2026

(54) Audio & Timecode Splitter

(71) Applicant: Multiply Audio LLC, Covington, GA (US)

(72) Inventor: Stephen Smith, Covington, GA (US)

(73) Assignee: Multiply Audio LLC, Covington, GA (US)

(21) Appl. No.: 19/302,250

(22) Filed: Aug. 18, 2025

Related U.S. Application Data
(60) Provisional application No. 63/688,381, filed on Aug. 29, 2024.

(51) Int. Cl. H04N 5/268; H04N 5/265; H04R 1/08; H04R 3/00

(52) U.S. Cl. CPC H04N 5/268; H04N 5/265; H04R 1/08; H04R 3/005

(57) ABSTRACT

An audio splitter is often used with a mixer or other source to take left and right stereo inputs into spaced apart input jacks of a housing and output at least four separate outputs at spaced apart output jacks on the housing for communicating those inputs to the outputs, often for use by cameras. More sophisticated versions include the ability to receive a timecode as an input at a separate jack and then output the timecode as an output at each of the output jacks. Still further sophisticated versions receive a return signal at each of the output jacks which can be monitored or utilized for further processing.

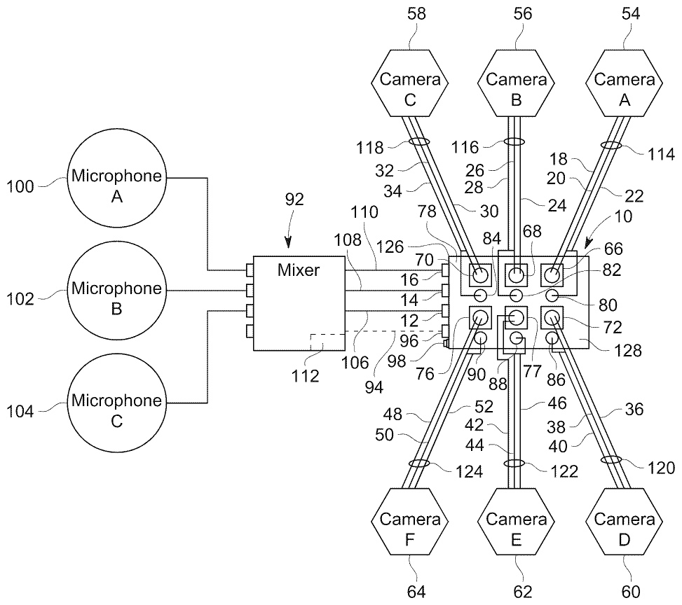

### CLAIM OF PRIORITY

This application claims the benefit of U.S. Provisional Application No. 63/688,381 filed Aug. 29, 2024, which is incorporated herein by reference in its entirety.

### FIELD OF THE INVENTION

The present invention relates to an audio and timecode splitter which preferably provides a box which receives stereo output, normally from a mixer along with timecode data, and then splits those signals to provide the same audio feeds to a plurality of cameras. Some embodiments have a return feed and selector switch to selectively permit audio from specific cameras to be sent back to the mixer for monitoring audio at specific camera.

### BACKGROUND OF THE INVENTION

Audio splitters have existed for many years to take a single audio signal input and direct that same input to multiple outputs. However, each signal has required its own splitter system and therefore, when connecting to mixer outputs having a timecode generator, it would take at least three, if not more, spaced apart, and separate splitters to send stereo output of the mixer (2 signals) along with timecode (a third signal) to send those as the same output to multiple cameras. Not only are there three separate splitter boxes, for a six camera system, there would then be six separate cables being directed from each of the three splitter boxes. To be able to receive audio from any of those cameras back to the mixer would take even more wiring.

Accordingly, a need exists to simplify the splitting of audio signals from a mixer to be sent to multiple cameras.

A need also exists, for at least some embodiments for an ability to receive audio from cameras in an easy to wire manner in order to provide that signal back to the mixer for at least monitoring purposes.

### BRIEF DESCRIPTION OF DRAWINGS

The particular features and advantages of the invention as well as other objects will become apparent from the following description taken in connection with the accompanying drawings in which:

The FIGURE is a schematic showing components of the audio splitter and related components of a presently preferred embodiment of the present invention.

### DETAILED DESCRIPTION OF THE PREFERRED EMBODIMENTS

The FIGURE shows a schematic of a presently preferred embodiment of the present invention of an audio splitter 10 connected to a mixer 92 receiving inputs from microphones A-C 100,102,104 and sending output to video cameras A-F 54,56,58,60,62,64. The audio splitter 10 receives a timecode input 12, and preferably first and second stereo inputs 14,16. The splitter 10 then splits these inputs and provides multiple identical outputs as stereo outputs 18,20, 24,26, 30,32, 36,38, 42,44, and 48,50 which are directed to inputs of six video cameras, typically utilized to record interviews or other purposes (so as to provide an ability to later edit and switch between camera recordings to provide a more interesting video than could normally be obtained from a single camera. Editing is simplified by the ability to split timecode input 12 into timecode outputs 22, 28, 34, 40, 46, 52 for a six camera system as illustrated. It will be understood by those of ordinary skill in the art, that splitter boxes 10 other than six camera boxes (like the one illustrated), may be used, such as, but not limited to four camera boxes, ten camera boxes, etc.

The stereo outputs 18,20, 24,26, 30,32, 36,38, 42,44, and 48,50 and timecode outputs 22, 28, 34, 40, 46, 52 are respectively grouped preferably so that a single cable, such as an XLR or other cable can separately transmit both channels of the stereo signals and possibly the timecode to a specific camera, such as any of video cameras A-F, 54,56,58,60,62,64, unless separate timecode cables are utilized to provide timecode data to the cameras in a separate cable from the XLR cable, such as a BNC cable or other cable.

In order to accomplish this, the stereo outputs 18,20, 24,26, 30,32, 36,38, 42,44, and 48,50 and timecode outputs 22, 28, 34, 40, 46, 52 are provided at spaced apart jacks, such as five-pin connector at jacks 66,68,70,72,74,76 on the housing 78 of the audio splitter. Two of those five pins can provide the appropriate stereo signals. A timecode signal could be sent through the appropriate XLR cable or separate jack 80,82,84,86,88, 90.

For at least some embodiments, an audio signal from at least some, if not all of the cameras A-F 54,56,58,60,62,64, is desired to be monitored. In such situations, seven pin connector at jacks 66,68,70,72,74,76 is useful so that a return audio signal from the camera can be returned from any of the cameras A-F 54,56,58,60,62,64 to the splitter 10, and then back to a mixer 92, such as through a stereo or other cable 94 from output 96. Selector switch 98 may be provided to select which of the various cameras A-F 54,56,58,60,62,64 are selected to provide an output back to the mixer 92.

For many embodiments, mixer 92 provides the outputs of the stereo channels as inputs 14,16 to the splitter at jacks in the housing, such as through three pin connectors or other connectors from XLR or other cables 108,110 from the mixer 92. Timecode input 12 may be provided separately from a 5 pin limo to a BNC connector through cable 106 for some embodiments.

Mixer 92 receives as inputs audio, such as from a plurality of microphones A-C 100,102,104. Other numbers of microphones may be used as a number and/or type of input to mixer 92. Mixer 92 has an internal timecode generator 112 for many embodiments.

By providing a housing 78 with the capability of splitting the stereo inputs to combine with timecode data and send to multiple cameras A-F 54,56,58,60,62,64, a unique ability exists to compactly provide sound and timecode information to each camera A-F 54,56,58,60,62,64, so that various camera shots can be combined/switched during a shoot during editing to create a pleasing finished product by an editor/producer.

For the sound technician, a single splitter 10 may be employed instead of three, and when using XLR cables, it may be only six cables from the splitter 10 to cameras A-F 54,56,58,60,62,64, may be utilized, for at least some embodiments, thereby making set up much more quick than prior art systems and methodology.

While XLR cables are presently preferred, coaxial cables 114,116,118,120,122,124 may be utilized with other embodiments. Audio cable is presently believed to be more flexible than coaxial cable, and easier to employ. Still other cable types may prove advantageous in other embodiments.

The audio splitter 10 may be compact and easy to use by sound technicians to provide for quick set up and takedown for a specific event. Inputs 12,14, 16 on side 126 of housing 78 may be perpendicularly oriented relative to outputs such as stereo outputs 18,20, 24,26, 30,32, 36,38, 42,44, and 48,50 and timecode outputs 22, 28, 34, 40, 46, 52 on top 128 of housing 78 for at least some embodiments. Camera output 96 and/or selector switch 98 may be located on the same side 126 of housing 78 as the inputs 12, 14,16. Other embodiments may provide different orientations for inputs/outputs on the housing 78 of the audio splitter 10.

Numerous alterations of the structure herein disclosed will suggest themselves to those skilled in the art. However, it is to be understood that the present disclosure relates to the preferred embodiment of the invention which is for purposes of illustration only and not to be construed as a limitation of the invention. All such modifications which do not depart from the spirit of the invention are intended to be included within the scope of the appended claims.

1. An audio splitter comprising:
a. a housing;
b. first and second stereo inputs received at first and second connections, respectively on the housing; and
c. at least three output jacks on the housing communicating with the first and second connections, each of the output jacks receiving the first and second stereo inputs while maintaining them separate at the output jacks.

2. The audio splitter of claim 1 wherein the at least three output jacks further comprise at least four output jacks, each of the output jacks receiving the first and second stereo inputs while maintaining them separate at the output jacks.

3. The audio splitter of claim 1 outputting a timecode signal output from the housing corresponding in number to a number of the output jacks.

4. The audio splitter of claim 3 further comprising timecode jacks on the housing, each of which receive the timecode output.

5. The audio splitter of claim 3 wherein the output jacks each receive the timecode output while maintaining the timecode output separate from the stereo inputs at the output jacks.

6. The audio splitter of claim 3 further receiving timecode input from a source external to the housing through the housing.

7. The audio splitter of claim 6 wherein the timecode input is spaced from the stereo inputs.

8. The audio splitter of claim 1 in combination with a mixer wherein outputs of the mixer provide at least the first and second stereo inputs of the audio splitter.

9. The audio splitter of claim 8 wherein the mixer receives input from multiple microphones and then provides the first and second stereo inputs of the audio splitter.

10. The audio splitter of claim 8 wherein the mixer provides the timecode input.

11. The audio splitter of claim 10 wherein the mixer has a timecode generator providing the timecode input to the audio splitter.

12. The audio splitter of claim 1 in combination with at least three cameras which respectively connect with cables to the output jacks on the housing.

13. The audio splitter of claim 12 wherein the at least one of the cameras directs a return audio signal through its cable back to the audio splitter through the output jack through which it is connected.

14. The audio splitter of claim 13 wherein all of the output jacks are configured to receive return audio signals through the output jacks.

15. The audio splitter of claim 14 further comprising a selector switch and a return output directed from the housing spaced from the output jacks whereby a user selects which of the return audio signals are directed through the return output.

16. The audio splitter of claim 1 further comprising a return audio signal received at the audio splitter into an output jack.

17. The audio splitter of claim 16 wherein all of the output jacks are configured to receive the return audio signal.

18. The audio splitter of claim 14 further comprising a selector switch and a return output directed from the housing spaced from the output jacks whereby a user selects which output jack directs the return audio signal through the return output.

19. The audio splitter of claim 18 wherein the return output is located on the same side of the housing as the first and second stereo inputs.

20. The audio splitter of claim 1 wherein the first and second stereo inputs are disposed perpendicularly on the housing relative to the output jacks.
